(19) United States
(12) Patent Application Publication
(10) Pub. No.: US 2026/0338342 A1
(43) Pub. Date: Oct. 29, 2026

(54) LIGHTING DEVICE

(71) Applicant: Ford Global Technologies, LLC, Dearborn, MI (US)

(72) Inventors: Zhenhai Kong, Nanjing (CN); Qiming Sun, Nanjing (CN); Wei Xu, Nanjing (CN); Liangquan Dai, Nanjing (CN)

(73) Assignee: Ford Global Technologies, LLC, Dearborn, MI (US)

(21) Appl. No.: 19/659,379

(22) Filed: Apr. 27, 2026

(30) Foreign Application Priority Data
Apr. 28, 2025 (CN) 202520832142.8

(51) Int. Cl. F21S 41/29; F21S 41/24; F21V 15/01; F21V 17/16; F21W 104/00

(52) U.S. Cl. CPC F21S 41/29; F21S 41/24; F21V 15/01; F21V 17/16; F21W 2104/00

(57) ABSTRACT

A lighting device includes a housing, a light source disposed within the housing, and a light guide partially fitted into the receiving hole. The light guide has a light incident end disposed adjacent to the light source. In a cross-section perpendicular to the axial direction, the receiving hole has a polygonal profile, the light guide has a profile selectively selected from a circular light guide profile and at least one polygonal light guide profile, and the light guide is engaged with at least two opposite sides of the polygonal profile of the receiving hole. A unified receiving hole can be employed to match light guides with different shapes. In addition, the receiving hole having a polygonal cross-section can provide a certain holding effect on the light guide, prevent or reduce rotation of the light guide, and ensure normal and stable operation of the lighting device.

### CROSS-REFERENCE TO RELATED APPLICATION

This application claims foreign priority benefits under 35 U.S.C. § 119(a)-(d) to China Application No. 202520832142.8 filed Apr.28, 2025, which is hereby incorporated by reference in its entirety.

### FIELD OF THE DISCLOSURE

The present disclosure generally relates to the field of vehicles, and in particular to a lighting device.

### BACKGROUND OF THE DISCLOSURE

Vehicles are commonly provided with lighting devices for decoration and/or indication. Such lighting devices can enhance the visual appearance of the vehicle and/or assist vehicle occupants in operation. Some lighting devices typically include a housing, a light source disposed within the housing, and a light guide partially inserted into a receiving hole of the housing. The cross-sectional shape of the insertion portion of the light guide may be designed in various shapes such as circular and polygonal (e.g., square, hexagonal). It may be desirable to provide a housing capable of receiving light guides with different shapes.

### SUMMARY OF THE DISCLOSURE

According to a first aspect of the present disclosure, a lighting device includes a housing having a receiving hole extending in an axial direction, a light source disposed within the housing and a light guide partially fitted into the receiving hole. The light guide includes a light incident end disposed adjacent to the light source. In a cross-section perpendicular to the axial direction, the receiving hole has a polygonal hole profile, the light guide has a light guide profile selectively selected from a circular light guide profile and at least one polygonal light guide profile, and the light guide is engaged with at least two opposite sides of the polygonal hole profile of the receiving hole.

Embodiments of the first aspect of the present disclosure can include any one or a combination of the following features:
in the cross-section, the light guide circular profile of the light guide is tangent to at least two opposite sides of the polygonal hole profile of the receiving hole;
in the cross-section, the receiving hole has a regular polygonal hole profile, and the circular light guide profile of the light guide is tangent to each side of the regular polygonal hole profile of the receiving hole;
in the cross-section, at least two opposite sides of the polygonal light guide profile of the light guide are respectively engaged with at least two opposite sides of the polygonal hole profile of the receiving hole;
in the cross-section, the light guide and the receiving hole have an identical regular polygonal profile and are substantially equal in size;
in the cross-section, at least two opposite corners of the polygonal light guide profile of the light guide are respectively engaged with at least two opposite sides of the polygonal hole profile of the receiving hole;
in the cross-section, at least one corner of the polygonal light guide profile of the light guide and at least one side opposite to the at least one corner are respectively engaged with at least two opposite sides of the polygonal hole profile of the receiving hole;
wherein the light guide is formed with a recess on a side surface thereof, the recess extending from the light incident end in the axial direction, a wall of the receiving hole is formed with a protrusion extending in the axial direction, an end surface of the recess cooperates with an end surface of the protrusion to restrict movement of the light guide toward the light source, and a side surface of the recess cooperates with a side surface of the protrusion to restrict rotational movement of the light guide;
wherein the light guide is formed with a projection on a side surface thereof, a wall of the receiving hole is formed with a hook, and an end surface of the projection cooperates with an end surface of the hook to restrict movement of the light guide away from the light source;
the wall of the receiving hole defines an opening, and the hook extends from the wall of the receiving hole and is located within the opening; and
the lighting device is configured to be applied to a vehicle.

According to a second aspect of the present disclosure, a vehicle lighting device includes a housing having a receiving hole extending in an axial direction, a light source disposed within the housing and a light guide partially fitted into the receiving hole. The light guide has a light incident end disposed adjacent to the light source. In a cross-section perpendicular to the axial direction, the receiving hole has a polygonal hole profile, the light guide has a light guide profile selectively selected from a circular light guide profile and at least one polygonal light guide profile, and the light guide is engaged with at least two opposite sides of the polygonal hole profile of the receiving hole. In the cross-section, the circular light guide profile of the light guide is tangent to at least two opposite sides of the polygonal hole profile of the receiving hole.

Embodiments of the second aspect of the present disclosure can include any one or a combination of the following features:
in the cross-section, the receiving hole has a regular polygonal hole profile, and the circular light guide profile of the light guide is tangent to each side of the regular polygonal hole profile of the receiving hole;
in the cross-section, at least two opposite sides of the polygonal light guide profile of the light guide are respectively engaged with at least two opposite sides of the polygonal hole profile of the receiving hole;
in the cross-section, the light guide and the receiving hole have an identical regular polygonal profile and are substantially equal in size;
in the cross-section, at least two opposite corners of the polygonal light guide profile of the light guide are respectively engaged with at least two opposite sides of the polygonal hole profile of the receiving hole;
in the cross-section, at least one corner of the polygonal light guide profile of the light guide and at least one side opposite to the at least one corner are respectively engaged with at least two opposite sides of the polygonal hole profile of the receiving hole;
the light guide is formed with a recess on a side surface thereof, the recess extending from the light incident end in the axial direction, a wall of the receiving hole is formed with a protrusion extending in the axial direction, an end surface of the recess cooperates with an end surface of the protrusion to restrict movement of the light guide toward the light source, and a side surface of the recess cooperates with a side surface of the protrusion to restrict rotational movement of the light guide;
the light guide is formed with a projection on a side surface thereof, a wall of the receiving hole is formed with a hook, and an end surface of the projection cooperates with an end surface of the hook to restrict movement of the light guide away from the light source; and
the wall of the receiving hole defines an opening, and the hook extends from the wall of the receiving hole and is located within the opening.

For a better understanding of the present disclosure, reference may be made to embodiments depicted in the following drawings. The components in the drawings are not necessarily to scale and related elements may be omitted, or in some instances proportions may have been exaggerated, so as to emphasize and clearly illustrate the novel features described herein. In addition, system components can be variously arranged, as known in the art. Further in the drawings, like reference numbers refer to like parts throughout the different drawings.

### BRIEF DESCRIPTION OF THE DRAWINGS

### In the drawings

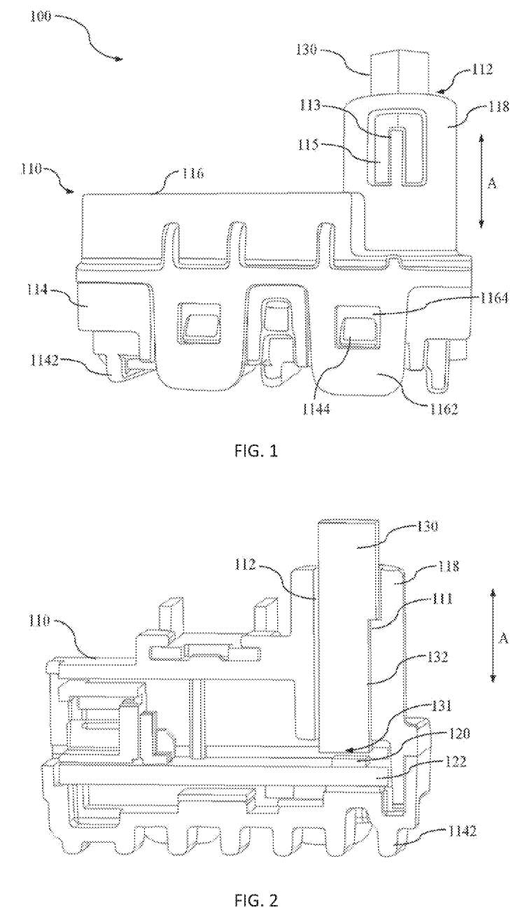

FIG. 1 is an overall schematic view of a lighting device according to an embodiment of the present disclosure;

FIG. 2 is a cross-sectional view of the lighting device according to an embodiment of the present disclosure;

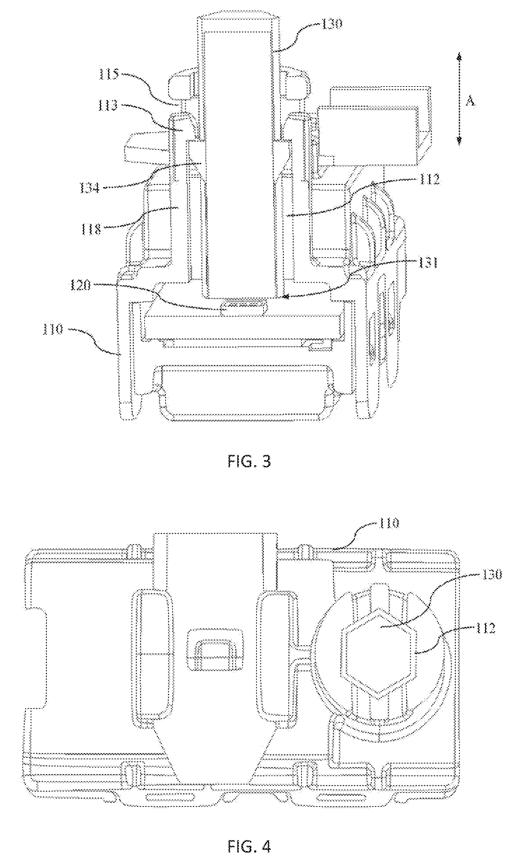

FIG. 3 is another cross-sectional view of the lighting device according to an embodiment of the present disclosure;

FIG. 4 is another cross-sectional view of the lighting device according to an embodiment of the present disclosure;

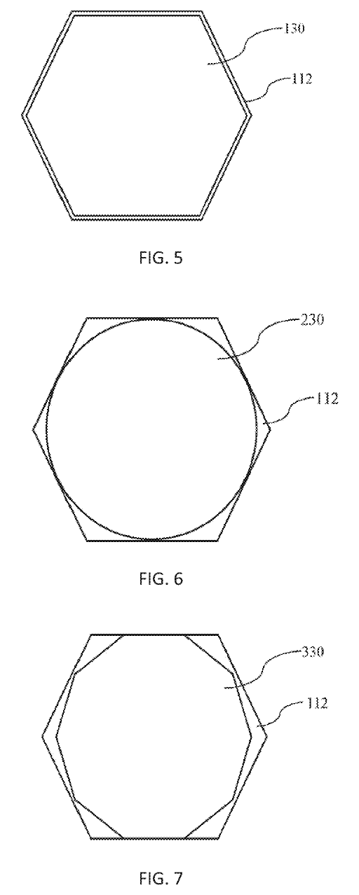

FIG. 5 is a schematic view of a light guide and a receiving hole according to an embodiment of the present disclosure;

FIG. 6 is a schematic view of the light guide and the receiving hole according to another embodiment of the present disclosure;

FIG. 7 is a schematic view of the light guide and the receiving hole according to another embodiment of the present disclosure;

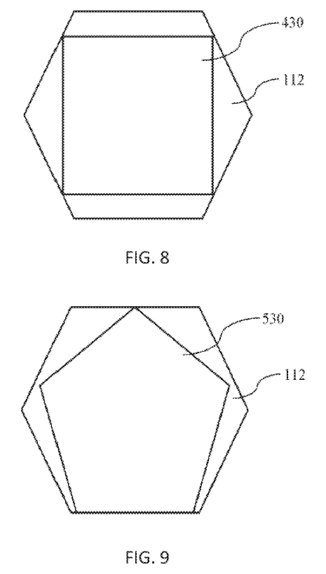

FIG. 8 is a schematic view of the light guide and the receiving hole according to another embodiment of the present disclosure; and

FIG. 9 is a schematic view of the light guide and the receiving hole according to another embodiment of the present disclosure.

### DETAILED DESCRIPTION OF PREFERRED EMBODIMENTS

While the present disclosure may be embodied in various forms, some exemplary and non-limiting embodiments are shown in the drawings and will be described hereinafter. It should be understood, however, that these are to be considered as examples of the present disclosure and are not intended to limit the present disclosure to the specific embodiments illustrated.

The insertion portion of the light guide may be designed with various cross-sectional shapes. It is therefore desirable to provide a housing that can match light guides with different shapes. In this way, compared with providing different types of housings for light guides with different shapes, the number of housing types can be reduced, thereby enhancing efficiencies for mold development and production. In addition, the steps of selecting housing types and managing different types of housings can be omitted, making assembly simpler. Furthermore, a circular receiving hole may provide insufficient support for the light guide, and the light guide may tend to rotate, which may affect light efficiency (such as light output direction, brightness, etc.). The present disclosure provides, in one or more embodiments, an enhanced lighting device.

FIG. 1 shows an overall schematic view of a lighting device 100 according to an embodiment of the present disclosure, and FIGS. 2-4 show various cross-sectional views of the lighting device 100. Referring to FIGS. 1-4, the lighting device 100 includes a housing 110, a light source 120 disposed within the housing 110, and a light guide 130. The housing 110 has a receiving hole 112 extending in an axial direction A. The light guide 130 is partially fitted into the receiving hole 112, and a light incident end 131 of the light guide 130 is disposed adjacent to the light source 120.

The lighting device 100 may further include a PCB (Printed Circuit Board) 122 disposed in the housing 110, and the light source 120 is disposed on the PCB 122. The light source 120 may include any type of light source; for example, a light-emitting diode (LED), organic light-emitting diode (OLED), polymer light-emitting diode (PLED), fluorescent lighting device, laser lighting device, or the like may be used.

The light guide 130 may be a generally transparent or translucent guide adapted to transmit light, such as light emitted from the light source 120. The light guide 130 may be a flexible light guide, made of a suitable flexible material. Light emitted by the light source 120 enters the light guide 130 from the light incident end 131 and is guided by the light guide 130 to a desired light output position. The light guide 130 and the light source 120 may be aligned along the axial direction A, with an appropriate axial distance maintained therebetween. In some embodiments, the size and/or profile of the light guide 130 may be uniform along the extending direction of the light guide 130. In other embodiments, the light guide 130 may be composed of multiple segments having different sizes and/or profiles.

The housing 110 may include a base portion 114 that carries the PCB 122, and a cover portion 116 that covers the PCB 122 and the light source 120 and is connected to the base portion 114. The base portion 114 and/or the cover portion 116 form an accommodating cavity for receiving the PCB 122 and the light source 120. The base portion 114 and the cover portion 116 may be connected in any suitable manner, such as fixed connection by welding, bonding, or the like, or detachable connection by fasteners, clamping, or the like to facilitate inspection and replacement of components inside the housing 110. The receiving hole 112 may be formed on the cover portion 116. The cover portion 116 may include a wall 118 that defines the receiving hole 112. A portion of the wall 118 may protrude relative to a top surface of the cover portion 116 so as to provide the receiving hole 112 with a certain axial dimension for stable engagement with the light guide 130. The wall 118 may be a hollow columnar structure. The wall 118 may be located on one side of the cover portion 116; of course, the position of the wall 118 may be set according to actual conditions to ensure that the light incident end 131 of the light guide 130 is aligned with the light source 120.

In some embodiments of the present disclosure, the base portion 114 may include a bottom wall and a first surrounding side wall extending from the bottom wall, and the cover portion 116 may include a top wall and a second surrounding side wall extending from the top wall, wherein the first surrounding side wall and the second surrounding side wall are engaged. The first surrounding side wall may form lugs 1162 extending along the second surrounding side wall, and fitting holes 1164 are formed on the lugs 1162. Projections 1144 that engage with the fitting holes 1164 may be formed on the second surrounding side wall. The engagement between the projections 1144 and the fitting holes 1164 prevents separation of the cover portion 116 from the base portion 114. A plurality of heat dissipation fins 1142 may be provided on the bottom wall of the base portion 114. The PCB 122 may be carried on at least two opposite surfaces of the first surrounding side wall of the base portion 114 with a gap from the bottom wall.

In embodiments of the present disclosure, in the same cross-section perpendicular to the axial direction A, the receiving hole 112 has a polygonal profile, and the light guide has a profile selectively selected from a circular profile and at least one polygonal profile. FIGS. 5-9 of the present disclosure show schematic views of the receiving hole 112 engaged with light guides of different cross-sectional profiles. Referring to FIGS. 5-9, the receiving hole 112 having a polygonal cross-section can be engaged with a light guide having a circular cross-section or any one of various polygonal cross-sections. Thus, a unified receiving hole 112 can be used to match light guides with different shapes, facilitating assembly and helping to enhance efficiencies. Furthermore, the light guide is engaged with at least two opposite sides of the polygonal profile of the receiving hole 112. The receiving hole 112 having a polygonal cross-section can provide a certain holding effect for the light guide (especially an effective holding effect for a polygonal light guide), preventing or reducing rotation of the light guide and ensuring stable and normal operation of the lighting device. Compared with forming mutually engaging concave-convex structures on the light guide and the hole wall to prevent rotation, the present application limits the light guide based on at least two opposite sides of the polygonal receiving hole, thereby achieving a more stable and reliable anti-rotation effect.

In embodiments of the present disclosure, the engagement between the light guide and a side of the polygonal profile of the receiving hole 112 may include: contact between the light guide and the corresponding side of the polygonal profile, a clearance not exceeding a predetermined value (e.g., not more than 0.5 mm), or an interference fit. For a polygonal light guide, the polygonal receiving hole 112 can effectively restrict its rotation. When the clearance between the light guide and the sides of the polygonal profile of the receiving hole 112 is less than, for example, 0.5 mm, the wall 118 of the receiving hole 112 can restrict rotation of the light guide. Therefore, a small clearance may be provided between the light guide and the wall 118 of the receiving hole 112 to make assembly easier. For a circular light guide, an interference fit between the light guide and the wall 118 of the receiving hole 112 and/or a limiting structure as described below, for example, may be adopted to restrict rotation of the light guide.

In embodiments of the present disclosure, an opposite side of a given side in the polygon may be a side opposite to the given side, such as a side not adjacent to the given side, a side parallel to the given side, or a side not adjacent to and farthest from the given side. Any configuration that can restrict rotation of the light guide based on at least these two sides falls within the scope of opposite sides as defined in the present disclosure. For a regular polygon with an even number of sides, the opposite side of a given side may be a side parallel to the given side. For a regular polygon with an odd number of sides, the opposite side of a given side may be a side not adjacent to and farthest from the given side.

Referring to FIG. 6, in some embodiments, in the cross-section, the circular profile of the light guide 230 is tangent to at least two opposite sides of the polygonal profile of the receiving hole 112. In a specific embodiment, in the cross-section, the receiving hole 112 has a regular polygonal profile, and the circular profile of the light guide 230 is tangent to each side of the regular polygonal profile of the receiving hole 112; that is, the circular profile of the light guide 230 is an inscribed circle of the regular polygonal profile of the receiving hole 112. In this manner, the light guide 230 can be relatively stably restricted, preventing substantial displacement of the light guide 230 within the receiving hole 112.

Referring to FIG. 7, in one embodiment, in the cross-section, at least two opposite sides of the polygonal profile of the light guide 330 are respectively engaged with at least two opposite sides of the polygonal profile of the receiving hole 112. By limiting at least two opposite sides of the light guide 330 via at least two opposite sides of the receiving hole 112, rotation of the light guide 330 can be effectively restricted. As described above, “engaged” may include contact, a small clearance, or an interference fit. A clearance fit may be adopted to easily assemble the light guide 330 into the receiving hole 112.

Referring to FIG. 5, in one embodiment, in the cross-section, the light guide 130 and the receiving hole 112 have an identical regular polygonal profile, and are substantially equal in size. In this way, rotation of the light guide 130 can be restricted more effectively. The expression that the light guide 130 and the receiving hole 112 are substantially equal in size may mean that the difference between the size of the receiving hole 112 and the size of the light guide 130 is less than a predetermined value (e.g., 0.5 mm).

Referring to FIG. 8, in one embodiment, in the cross-section, at least two opposite corners of the polygonal profile of the light guide 430 are respectively engaged with at least two opposite sides of the polygonal profile of the receiving hole 112. By limiting at least two opposite corners of the light guide 430 via at least two opposite sides of the receiving hole 112, rotation of the light guide 430 can be effectively restricted.

Referring to FIG. 9, in one embodiment, in the cross-section, at least one corner of the polygonal profile of the light guide 530 and at least one side opposite to the at least one corner are respectively engaged with at least two opposite sides of the polygonal profile of the receiving hole 112. By limiting at least one corner of the light guide 530 and at least one side opposite thereto via at least two opposite sides of the receiving hole 112, rotation of the light guide 530 can be effectively restricted. In embodiments of the present disclosure, a side opposite to a corner may be a side not adjacent to the vertex of the corner, such as a side not adjacent to and farthest from the vertex of the corner.

Although FIGS. 5-9 schematically show that the cross-sectional profile of the receiving hole is a regular hexagon, it should be understood that the cross-sectional profile of the receiving hole may also be other polygons, as long as it can be engaged with circular and polygonal light guides and can restrict rotation of the polygonal light guides. Except for the different light guide profiles, other parts of the embodiments corresponding to FIGS. 6-9 may refer to the corresponding parts of the embodiment shown in FIGS. 1-4.

Referring again to FIG. 2, a recess 132 extending along the axial direction A from the light incident end 131 may be formed on a side surface of the light guide 130, and a protrusion 111 extending along the axial direction A may be formed on the wall 118 of the receiving hole 112. An end surface of the recess 132 cooperates with an end surface of the protrusion 111 to restrict movement of the light guide 130 toward the light source 120, thereby preventing contact with the light guide 130 caused by the light guide 130 being too close to the light source 120. At the same time, a side surface of the recess 132 cooperates with a side surface of the protrusion 111 to further restrict rotation of the light guide 130 and reduce adverse effects on light efficiency. The protrusion 111 may be an elongated structure, and the recess 132 may be an elongated notch.

Referring to FIGS. 1 and 3, a projection 134 may be formed on a side surface of the light guide 130, and a hook 113 may be formed on the wall 118 of the receiving hole 112. An end surface of the projection 134 cooperates with an end surface of the hook 113 to restrict movement of the light guide 130 away from the light source 120, preventing the light guide 130 from sliding out of the housing 110 and reducing light efficiency. The hook 113 and the projection 134 may form mutually mating wedge-shaped guide surfaces, so that the light guide 130 can be smoothly and easily inserted into the receiving hole 112 during assembly. An opening 115 may be formed in the wall 118 of the receiving hole 112, and the hook 113 extends from the wall 118 of the receiving hole 112 and is located in the opening 115. This can enhance the deformability of the hook 113 and facilitate insertion of the light guide 130 during assembly.

When installing the light guide 130, the light guide 130 may first be rotated to align the recess 132 with the protrusion 111, and then the light guide 130 is inserted into the receiving hole 112 along the axial direction A until the end surface of the recess 132 cooperates with the end surface of the protrusion 111. At this point, the projection 134 slides into a position where its end surface cooperates with the end surface of the hook 113, completing the installation.

The present disclosure provides a lighting device. With the present disclosure, a unified receiving hole can be employed to match light guides with different shapes, which facilitates assembly and helps with production efficiencies. In addition, the receiving hole having a polygonal cross-section can provide a certain holding effect on the light guide, prevent or reduce rotation of the light guide, and ensure normal and stable operation of the lighting device.

According to an aspect of the present disclosure, a lighting device is provided, having a housing, a light source disposed within the housing and a light guide. The housing has a receiving hole extending in an axial direction. The light guide is partially fitted into the receiving hole, and a light incident end of the light guide is disposed adjacent to the light source. Wherein, in a cross-section perpendicular to the axial direction, the receiving hole has a polygonal profile, the light guide has a profile selectively selected from a circular profile and at least one polygonal profile, and the light guide is engaged with at least two opposite sides of the polygonal profile of the receiving hole.

According to an embodiment of the present disclosure, in the cross-section, the circular profile of the light guide is tangent to at least two opposite sides of the polygonal profile of the receiving hole.

According to one embodiment of the present disclosure, in the cross-section, the receiving hole has a regular polygonal profile, and the circular profile of the light guide is tangent to each side of the regular polygonal profile of the receiving hole.

According to one embodiment of the present disclosure, in the cross-section, at least two opposite sides of the polygonal profile of the light guide are respectively engaged with at least two opposite sides of the polygonal profile of the receiving hole.

According to one embodiment of the present disclosure, in the cross-section, the light guide and the receiving hole have an identical regular polygonal profile and are substantially equal in size.

According to one embodiment of the present disclosure, in the cross-section, at least two opposite corners of the polygonal profile of the light guide are respectively engaged with at least two opposite sides of the polygonal profile of the receiving hole.

According to one embodiment of the present disclosure, in the cross-section, at least one corner of the polygonal profile of the light guide and at least one side opposite to the at least one corner are respectively engaged with at least two opposite sides of the polygonal profile of the receiving hole.

According to one embodiment of the present disclosure, the light guide is formed with a recess on a side surface thereof, the recess extending from the light incident end in the axial direction, a wall of the receiving hole is formed with a protrusion extending in the axial direction, an end surface of the recess cooperates with an end surface of the protrusion to restrict movement of the light guide toward the light source, and a side surface of the recess cooperates with a side surface of the protrusion to restrict rotational movement of the light guide.

According to one embodiment of the present disclosure, the light guide is formed with a projection on a side surface thereof, a wall of the receiving hole is formed with a hook, and an end surface of the projection cooperates with an end surface of the hook to restrict movement of the light guide away from the light source.

According to one embodiment of the present disclosure, the wall of the receiving hole defines an opening, and the hook extends from the wall of the receiving hole and is located within the opening.

The lighting device in one or more embodiments of the present disclosure may be applied to a vehicle. The vehicle may be a standard gasoline-powered vehicle, a hybrid vehicle, an electric vehicle, a fuel cell vehicle, a two- or three-wheeled vehicle, a watercraft, an aircraft, and/or any other type of transportation tool. The vehicle includes mobility-related components such as an engine, an electric motor, a transmission, a suspension, a drive shaft, and/or wheels. The vehicle further includes components related to vehicle control, such as a vehicle controller, a vehicle bus, etc. The vehicle controller may be connected to in-vehicle components via the vehicle bus to control these components. The vehicle may be non-autonomous, semi-autonomous (e.g., some conventional motion functions are controlled by the vehicle), or autonomous (e.g., motion functions are controlled by the vehicle without direct input from a driver).

It should be understood that, where technically feasible, the technical features described above for different embodiments may be combined with each other to form further embodiments within the scope of the present disclosure. In addition, the specific examples and embodiments described herein are non-limiting, and corresponding modifications may be made to the structures, dimensions, and materials set forth above without departing from the scope of protection of the present disclosure.

The use of disjunctive is intended to include the conjunctive. The use of definite or indefinite articles is not intended to indicate cardinality. In particular, reference to “the” object or “a” and “an” object is intended to mean one of possibly more such objects. Furthermore, the conjunction “or” may be used to convey the coexistence of features rather than mutually exclusive alternatives. In other words, the conjunction “or” should be understood to include “and/or”. The term “comprising” is inclusive and has the same scope as “including”.

The above-described embodiments, particularly any “preferred” embodiments, are possible examples of implementations and are presented merely for a clear understanding of the principles of the present disclosure. Many variations and modifications may be made to the above-described embodiments without departing substantially from the spirit and principles of the technology described herein. All such modifications are intended to be included within the scope of the present disclosure.

It is to be understood that variations and modifications can be made on the aforementioned structure without departing from the concepts of the present disclosure, and further it is to be understood that such concepts are intended to be covered by the following claims unless these claims by their language expressly state otherwise.

What is claimed is:

1. A lighting device comprising:
a housing having a receiving hole extending in an axial direction;
a light source disposed within the housing; and
a light guide partially fitted into the receiving hole, the light guide having a light incident end disposed adjacent to the light source, wherein, in a cross-section perpendicular to the axial direction, the receiving hole has a polygonal hole profile, the light guide has a light guide profile selectively selected from a circular light guide profile and at least one polygonal light guide profile, and the light guide is engaged with at least two opposite sides of the polygonal hole profile of the receiving hole.

2. The lighting device according to claim 1, wherein in the cross-section, the circular light guide profile of the light guide is tangent to at least two opposite sides of the polygonal hole profile of the receiving hole.

3. The lighting device according to claim 2, wherein in the cross-section, the receiving hole has a regular polygonal hole profile, and the circular light guide profile of the light guide is tangent to each side of the regular polygonal hole profile of the receiving hole.

4. The lighting device according to claim 1, wherein in the cross-section, at least two opposite sides of the polygonal light guide profile of the light guide are respectively engaged with at least two opposite sides of the polygonal hole profile of the receiving hole.

5. The lighting device according to claim 4, wherein in the cross-section, the light guide and the receiving hole have an identical regular polygonal profile and are substantially equal in size.

6. The lighting device according to claim 1, wherein in the cross-section, at least two opposite corners of the polygonal light guide profile of the light guide are respectively engaged with at least two opposite sides of the polygonal hole profile of the receiving hole.

7. The lighting device according to claim 1, wherein in the cross-section, at least one corner of the polygonal light guide profile of the light guide and at least one side opposite to the at least one corner are respectively engaged with at least two opposite sides of the polygonal hole profile of the receiving hole.

8. The lighting device according to claim 1, wherein the light guide is formed with a recess on a side surface thereof, the recess extending from the light incident end in the axial direction, a wall of the receiving hole is formed with a protrusion extending in the axial direction, an end surface of the recess cooperates with an end surface of the protrusion to restrict movement of the light guide toward the light source, and a side surface of the recess cooperates with a side surface of the protrusion to restrict rotational movement of the light guide.

9. The lighting device according to claim 1, wherein the light guide is formed with a projection on a side surface thereof, a wall of the receiving hole is formed with a hook, and an end surface of the projection cooperates with an end surface of the hook to restrict movement of the light guide away from the light source.

10. The lighting device according to claim 9, wherein the wall of the receiving hole defines an opening, and the hook extends from the wall of the receiving hole and is located within the opening.

11. The lighting device according to claim 1, wherein the lighting device is configured to be applied to a vehicle.

12. A vehicle lighting device comprising:
a housing having a receiving hole extending in an axial direction;
a light source disposed within the housing; and
a light guide partially fitted into the receiving hole, the light guide having a light incident end disposed adjacent to the light source, wherein, in a cross-section perpendicular to the axial direction, the receiving hole has a polygonal hole profile, the light guide has a light guide profile selectively selected from a circular light guide profile and at least one polygonal light guide profile, and the light guide is engaged with at least two opposite sides of the polygonal hole profile of the receiving hole, and wherein in the cross-section, the circular light guide profile of the light guide is tangent to at least two opposite sides of the polygonal hole profile of the receiving hole.

13. The vehicle lighting device according to claim 12, wherein in the cross-section, the receiving hole has a regular polygonal hole profile, and the circular light guide profile of the light guide is tangent to each side of the regular polygonal hole profile of the receiving hole.

14. The vehicle lighting device according to claim 12, wherein in the cross-section, at least two opposite sides of the polygonal light guide profile of the light guide are respectively engaged with at least two opposite sides of the polygonal hole profile of the receiving hole.

15. The vehicle lighting device according to claim 14, wherein in the cross-section, the light guide and the receiving hole have an identical regular polygonal profile and are substantially equal in size.

16. The vehicle lighting device according to claim 12, wherein in the cross-section, at least two opposite corners of the polygonal light guide profile of the light guide are respectively engaged with at least two opposite sides of the polygonal hole profile of the receiving hole.

17. The vehicle lighting device according to claim 12, wherein in the cross-section, at least one corner of the polygonal light guide profile of the light guide and at least one side opposite to the at least one corner are respectively engaged with at least two opposite sides of the polygonal hole profile of the receiving hole.

18. The vehicle lighting device according to claim 12, wherein the light guide is formed with a recess on a side surface thereof, the recess extending from the light incident end in the axial direction, a wall of the receiving hole is formed with a protrusion extending in the axial direction, an end surface of the recess cooperates with an end surface of the protrusion to restrict movement of the light guide toward the light source, and a side surface of the recess cooperates with a side surface of the protrusion to restrict rotational movement of the light guide.

19. The vehicle lighting device according to claim 12, wherein the light guide is formed with a projection on a side surface thereof, a wall of the receiving hole is formed with a hook, and an end surface of the projection cooperates with an end surface of the hook to restrict movement of the light guide away from the light source.

20. The vehicle lighting device according to claim 19, wherein the wall of the receiving hole defines an opening, and the hook extends from the wall of the receiving hole and is located within the opening.
